(19) United States
(12) Patent Application Publication
(10) Pub. No.: US 2005/0246513 A1
(43) Pub. Date: Nov. 3, 2005

(54) Electronic control device and data adjustment method

(75) Inventor: Kaori Oba, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/117,326

(22) Filed: Apr. 29, 2005

(30) Foreign Application Priority Data
Apr. 30, 2004 (JP) 2004-135574

(51) Int. Cl. G06F 12/00

(52) U.S. Cl. 711/165

(57) ABSTRACT

A microcomputer has flash memory having at least two data areas, others of which can be written while one is being read, and substitute RAM which is used when adjusting control data prior to adjustment (pre-adjustment control data) which is stored in for example one of the data areas; the CPU controls equipment to be controlled by executing a program in a program storage portion using control data in one of the data areas. In adjustment processing of the control data, the control data in one of the data areas is copied to RAM and adjusted to values appropriate to the equipment to be controlled, and the adjusted control data is written to another data area, after which the addresses in a memory map of the two data areas are swapped. Subsequently, the CPU controls the equipment using the adjusted control data which physically is stored in the other data area.

### BACKGROUND OF THE INVENTION

1. Field of the Invention

This invention relates to an electronic control device and data adjustment method for an electronic control device which use control data to control a controlled portion, and in particular relates to an electronic control device and a data adjustment method for an electronic control device enabling adjustment of control data, while executing control of the controlled portion.

2. Description of the Related Art

In general, control programs, control parameters, and other data (hereafter called “control data”) used to control equipment or similar is often stored in nonvolatile memory (ROM) which is not erased even if a battery is removed, for supply to users.

Further, there are cases in which, after installing an electronic control device in a system, it is desired to adjust the control data according to the characteristics of the equipment to be controlled (calibration). Hence the control data is stored in for example an EEPROM (Electronically Erasable and Programmable Read-Only Memory), or in flash memory (flash EEPROM) or other rewritable nonvolatile memory.

However, the storage area of flash EEPROM is divided into a plurality of storage blocks, and during rewriting, data is erased and written in the storage block unit. For example, in the case of 64 kB flash EEPROM comprising two storage blocks with a storage capacity of 32 kilobytes (kB) each, data overwriting is performed for each 32 kB. However, while data rewrite processing is being performed in the flash EEPROM, data reading cannot be performed.

Further, the time required for data rewrite processing in the flash EEPROM is extremely long compared with the time required for overwriting in RAM (Random Access Memory). Consequently when calibration is performed according to the characteristics of equipment being controlled, normally the data for writing to flash EEPROM is temporarily stored in a debugger or other external storage device, and after the equipment being controlled has been stopped, the data stored in the external storage device is then used in flash EEPROM rewrite processing. Hence when performing a plurality of calibration operations for a single flash EEPROM, the above-described processing must be repeated for each calibration operation, and a considerable amount of trouble must be taken.

In Japanese Unexamined Patent Application Publication No. 2004-5296 (hereafter called the “Related Art Example”), an electronic control device is disclosed which is capable of performing data rewrite processing for nonvolatile memory even during control operation. FIG. 9 is a block diagram showing the electronic control unit (ECU) 110 described in the Related Art Example. Here, a case is explained in which, after the ECU 110 is installed in an automobile, in order to control for example the controlled portion 111 or other units comprised by the automobile, adjustment of control parameters which are control data (calibration) is performed.

As shown in FIG. 9, the ECU 110 comprises a CPU 200, flash EEPROM 201 as nonvolatile memory, and adjustment RAM 202 as volatile memory; the CPU 200 is configured to execute various programs stored in flash EEPROM 201, RAM for adjustment 202, and elsewhere. Data relating to control commands and control parameters when the ECU 110 executes control is recorded in flash EEPROM 201; for example, the ECU 110 may execute control of the controlled portion 111 through these control commands, and execute control parameter calibration processing and similar. For example, after the end of calibration, during overwriting of the control parameters in flash EEPROM 201, data erasure processing and write processing is performed in storage block units. The adjustment RAM 202 is memory for temporarily storing prescribed data during calibration, and has a storage capacity enabling storage of control parameters corresponding to the controlled portion 111.

The ECU 110 further has an input/output interface 220 for connection to a user interface portion 112, used to specify the controlled portion 111, finalize parameters, and similar; an address decoder 210, connected to the CPU 200 via an address bus; a flash control register 213, connected to the CPU 200 via a data bus, which holds addresses for writing to flash EEPROM 101 and adjusted control parameters; and a super-user mode register 212, connected to the CPU 200, which sets the rewrite mode of the flash EEPROM 201.

The address decoder 210 comprises an initialization register 211; the initialization register 211 comprises an area for recording data relating to the address of an area where calibration is performed, and an area for recording data relating to starting adjustment RAM 202 (start bit).

In the ECU 110, during processing when rewriting data recorded in flash EEPROM 201 with data appropriate to the controlled portion 111, first the user employs the user interface portion 112 to issue a calibration instruction for the controlled portion 111, while the ECU 110 is controlling the controlled portion 111 based on data recorded in flash EEPROM 201. By this means, calibration mode is set in the ECU 110. The CPU 200 determines the calibration area in flash EEPROM 201, and the data in the calibration area of flash EEPROM 201 is copied to the adjustment RAM 202.

At this time, the same addresses are assigned as memory addresses in adjustment RAM 202 and in the calibration area of flash EEPROM 201, and calibration processing is executed according to the characteristics of the controlled portion 111. That is, data read and rewrite processing is performed using the adjustment RAM 202 such that the optimum control parameters are used, and when there is an instruction to end calibration, processing (programming) is executed to write the control parameters recorded in adjustment RAM 202 to flash EEPROM 201.

That is, in the Related Art Example and similar, data in flash memory is overwritten as described below. FIG. 10A and FIG. 10B are figures explaining a conventional flash memory data rewrite method; FIG. 10A and FIG. 10B explain the rewrite method for the case in which there is one data area, and for the case in which there are a plurality of data areas, respectively.

As shown in FIG. 10A, a conventional electronic control device comprises flash memory having a program area in which application programs are stored and a data area 0 in which control parameters are stored, and RAM with capacity equal to or exceeding that of the data area 0; the electronic control device executes application programs, and while controlling devices to be controlled using control parameters stored in the data area 0, performs adjustment processing to search for the optimum values of control parameters. In this case, first the data in data area 0 is copied to RAM. Then, by rewriting control data in RAM, optimization of the control parameters (adjustment processing) is performed. When adjustment processing ends, the optimized control parameters in RAM are written back to data area 0.

When a plurality of data areas are used in order to handle a large quantity of control data, if control parameters in one data area are copied to RAM and adjusted and thereafter are written back as shown in FIG. 10A, time is required. Hence as for example shown in FIG. 10B, if for example RAM with the storage capacity of two data areas is prepared, data optimization can be performed for two data areas at once.

That is, in order to perform adjustment processing of a large quantity of control parameters, simultaneous parallel execution of adjustment of a plurality of control parameters to perform adjustment processing while application programs continue to be executed is necessary. Hence by providing the electronic control device with RAM having a large storage capacity, large quantities of data to be adjusted can be accommodated.

However, in the case of such a conventional adjustment method it is not possible to write back adjusted control parameters after calibration while the application program is being executed, and a dedicated program must be executed after execution of the application program to write back the data in RAM to the data area in flash memory. That is, because flash memory cannot simultaneously execute write and read operations, while writing of adjusted control parameters is being executed, control parameters cannot be read from flash memory. As explained above, the time required for data writing to flash memory is extremely long, and so the application program must be terminated.

Further, when controlling a device to be controlled using for example a large quantity of control parameters, the large quantity of control parameters must be adjusted to values appropriate to the device to be controlled. However, if the large quantity of control parameters is to be adjusted all at once, RAM with a large storage capacity must be installed, and there is the problem that the impact on costs is considerable. If on the other hand a small amount of RAM is to be used in adjustment processing of a large quantity of control parameters, as explained above, the application program must be halted temporarily, and processing to write back data to RAM must be repeated a plurality of times, so that there is the problem that an extremely long time is required for control parameter adjustment.

### SUMMARY OF THE INVENTION

According to one aspect of the present invention, there is provided an electronic control device, which executes adjustment processing to adjust control data to be appropriate for an equipment to be controlled, witch includes a nonvolatile storage portion, having a plurality of data storage areas, substitute memory, for use as a substitute for the nonvolatile storage portion when executing the adjustment processing of pre-adjustment control data, which is control data prior to adjustment stored in a data storage area of the nonvolatile storage portion, and, an adjustment processing portion, which reads the pre-adjustment control data from at least one data storage area among the plurality of data storage areas, executes adjustment processing of the pre-adjustment control data using the substitute memory, and writes adjusted control data, which is control data subjected to the adjustment processing, to another data storage area in the nonvolatile storage portion which is capable of writing independently of reading of the at least one data storage area.

According to the other aspect of the present invention, there is provided a data adjustment method of an electronic control device, which executes adjustment processing to adjust control data to be appropriate for an equipment to be controlled, witch includes reading pre-adjustment control data, which is control data before adjustment, from at least one data storage area of a nonvolatile storage portion which has a plurality of data storage areas, executing adjustment processing using substitute memory which can be used to substitute for the nonvolatile storage portion, and, writing adjusted control data, which is control data adjusted by the adjustment processing, to another data storage area in the nonvolatile storage portion which is capable of writing independently of the reading of the one or more data storage area.

By means of this invention, pre-adjustment control data, which is to be adjusted and is stored in the data storage area, is adjusted in substitute memory to values appropriate to the device to be controlled, and thereafter the adjusted control data is written to the data storage area separate from the data storage area in which the pre-adjustment control data had been stored, and which is the data area which can be written independently of the data storage area in which the pre-adjustment control data had been stored, so that control data adjustment is possible while continuing adjustment processing, and, for example, adjustment processing of control data in the next data storage area can be executed in succession. By this means, while executing adjustment processing to adjust control data to values appropriate to the device to be controlled, the adjusted control data can be written, so that even substitute memory with small storage capacity can be used to efficiently rewrite large quantities of control data.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a microcomputer in Aspect 1 of the invention;

FIG. 2A shows a memory map in the microcomputer of Aspect 1 of the invention;

FIG. 2B shows the accessibility of data areas;

FIG. 3A through FIG. 3D show the manner of data area optimization through an optimization processing procedure;

FIG. 4 is a flowchart showing an optimization method in an aspect of the invention;

FIG. 5 is a schematic drawing to explain the method of data optimization for the microcomputer 1 shown in FIG. 1;

FIG. 6 is a block diagram showing a microcomputer in Aspect 2 of the invention;

FIG. 7A shows the memory map recognized by the CPU 3 of the microcomputer 21 of Aspect 2 of the invention;

FIG. 7B shows the accessibility of data areas;

FIG. 8A through FIG. 8E show the manner of data area optimization through an optimization processing procedure;

FIG. 9 is a block diagram showing the electronic control unit (ECU) 110 described in the Related Art Example; and,

FIGS. 10A and 10B explain conventional method of overwriting data in flash memory, where 10A explains the overwriting method for the case of a single data area, and 10B explains the overwriting method for the case of a plurality of data areas.

### DESCRIPTION OF THE PREFERRED EMBODIMENTS

Below, specific embodiments of application of the invention are explained in detail, referring to the figures. These embodiments are applications of this invention to an electronic control device (hereafter called a “microcomputer”) which executes adjustment processing to adjust control data to values appropriate for a controlled device, while controlling the controlled device using control data stored in flash memory, as well as to the data adjustment method thereof. For example, if a microcomputer in an embodiment of the invention is employed in a system which determines parameters based on information from various sensors, processing (hereafter called “optimization processing”) can be executed to calculate and update values for control parameters used to control a controlled device which are appropriate to the controlled device.

### Embodiment 1

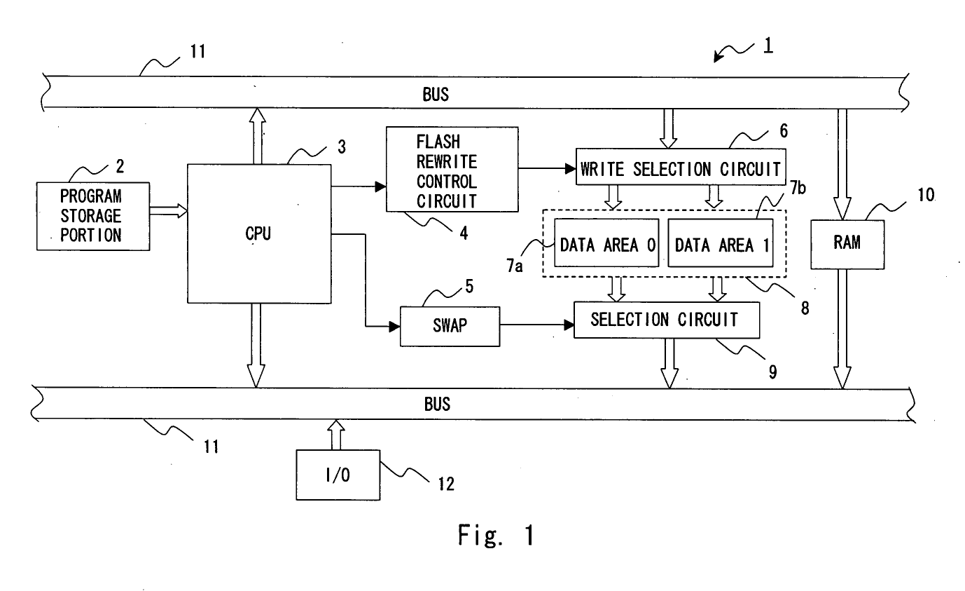

FIG. 1 is a block diagram showing a microcomputer 1 in this embodiment of the invention. As shown in FIG. 1, the microcomputer 1 has a program storage portion 2; CPU (Central Processing Unit) 3; flash memory (flash EPROM (Erasable Programmable Read-Only Memory)) 8; RAM 10; write selection circuit 6; read selection circuit 9; flash rewrite control circuit 4; swap register 5; I/O interface portion 12; and database 11 to exchange data with the CPU 3, write selection circuit 6, read selection circuit 9, RAM 10, and similar.

In the program storage portion 2 is stored an application program which executes control of equipment to be controlled (hereafter “the controlled equipment”). As is explained below, this program storage portion 2 is flash memory, ROM (Read-Only Memory) or other nonvolatile memory, in which is stored the application program to execute control of the controlled equipment using control data.

The flash memory 8 has a plurality of data areas (data storage areas), and control data is stored in these data areas.

In this embodiment, to simplify explanation, there are assumed to be first and second data storage areas 7a and 7b, storing two data items, data 0 and data 1. These data areas 7a and 7b are configured so as to enable independent read and rewrite processing. That is, while reading data from one of the data areas 7a, data can be written to the other data area 7b, so that a configuration is possible comprising first and second nonvolatile storage portions, each comprising separate memory access means enabling data reading, erasure, and writing in each of the data areas. Specifically, it is sufficient that each data area comprises a separate memory macro, in a configuration such that there are at least two data areas which can be read and written separately; of course the number of such data areas may also be three or greater.

Further, the data items data 0 and data 1 stored in the data areas 7a and 7b need be the minimum erasable units (block data) in the flash memory or greater; of course data areas may also can be stored a plurality of blocks of data.

The CPU 3 reads the application program from the program storage portion 2 and, by means of the application program, controls the controlled equipment using data stored in one of the data areas 7a or 7b of flash memory. Then, by means of instructions from external equipment, the CPU 3 executes adjustment processing (hereafter also called “optimization processing”) to adjust the control data to values appropriate to the controlled equipment.

Here, depending on the controlled equipment, there are cases in which adjustment processing is necessary, in which either default control data provided in advance, or the control data currently being used is adjusted (calibrated), to reset the control data to values appropriate to the controlled equipment. In this embodiment, default control data or the control data for which adjustment processing is required is called “pre-adjustment control data”, and control data for which adjustment processing has ended and which has been adjusted to the optimum values is called “adjusted control data”.

In this adjustment processing, the CPU 3 uses pre-adjustment control data, executes the application program, and while controlling the controlled equipment, executes processing to find the optimum values (adjusted control data).

The RAM 10 is volatile memory which is used as a substitute for data areas during execution of adjustment processing (optimization processing) to adjust pre-adjustment control data to control data appropriate to the controlled equipment. In adjustment processing, if pre-adjustment control data is being stored in data area 7a of the flash memory 8, the pre-adjustment control data read from this data area 7a is temporarily stored in RAM 10, which is substitute memory used as a substitute area for the data area 7a in adjustment processing. In adjustment processing, the CPU 3 accesses RAM 10, reads the pre-adjustment control data which is to be adjusted, and executes adjustment processing. Consequently during execution of adjustment processing, an address management portion, not shown, which manages memory addresses in flash memory 8 and RAM 10 changes the settings of addresses at which the pre-adjustment control data is stored from the data area 7a in flash memory 8 to addresses in RAM 10.

The flash rewrite control circuit 4 receives notification of the end of adjustment processing from the CPU 3 when adjustment processing ends and optimized values (adjusted control data) are fixed in RAM 10, and controls the write selection circuit 6 by outputting select signals to cause writing of optimized adjusted control data to the data area to which pre-adjustment control data had not been written among the data areas 7a and 7b of flash memory 8, and also by outputting select signals to cause erasure of data in one of the data areas 7a or 7b.

The write selection circuit 6 stores adjusted control data which has been adjusted through adjustment processing from a plurality of data areas in flash memory 8; first, based on a selection signal from the flash rewrite control circuit 4, the write selection circuit 6 selects one of the two data areas 7a and 7b in flash memory 8. In flash memory 8, memory access means, not shown, which performs data reading, erasure, and writing in a data area, erases the data in the selected data area or writes adjusted control data after adjustment processing. The data for writing is read from RAM 10, and is transferred over the bus 11.

The swap register 5 controls the read selection circuit 9, and as explained below, functions as address management means used to swap addresses in the data areas 7a and 7b. In this embodiment, of the two data areas 7a and 7b, one of the data areas is set as a data area which stores control data used to control the controlled equipment (and is normally accessed by the CPU 3), and the other data area is set for writing of adjusted control data which has been adjusted after adjustment processing. In this embodiment, of the two data areas 7a and 7b, the address of the data area used for normal access by the CPU 3 is the first address, and the address of the data area to which adjusted control data is written from RAM 10 after adjustment processing is called the second address.

For example, prior to executing adjustment processing, when pre-adjustment control data is stored in data area 7a, the address of data area 7a is set as the first address, and prior to adjustment processing control data is read from the data area 7a set as the first address to control the controlled equipment. When adjustment processing becomes necessary and adjustment processing is to be executed, control data in data area 7a set as the above first address is copied to RAM 10, and adjustment processing is executed. After adjustment processing, the adjusted control data is written to data area 7b, set as the second address. Finally, the address of data area 7b is set as the first address, and the address of data area 7a is set as the second address; that is, the addresses of data areas 7a and 7b are swapped. If thereafter, for example, adjustment processing is performed for control data in data area 7b set as the first address, and the result written to data area 7a as adjusted control data, the address of data area 7a is again set as the first address.

In this way, processing to exchange the addresses of data areas (hereafter called “swapping”) is performed such that after adjustment processing, the CPU 3 normally accesses the other data area 7b witch stored the adjusted control data. The swap register 5 is a register used to perform swapping, and holds information indicating which of the addresses of the data areas 7a and 7b hold is set as the first address or as the second address; after adjustment processing, this information is swapped. Details of the swap method are explained below. The swap method need only be sufficient to exchange the data areas, and is not limited to methods using such a register, but may for example entail mapping of the addresses of data areas 7a and 7b to nonvolatile memory.

The read selection circuit 9 selects one of the two data areas 7a or 7b of flash memory 8 and reads control data from the selected data area. That is, prior to adjustment processing, the data area in which is stored pre-adjustment control data which is to be subjected to adjustment processing is selected, based on data in the swap register 5. When the controlled equipment is being controlled, the data area in which is stored the most recent adjusted control data which has been adjusted is selected. The data read is sent to the CPU 3, RAM 10 or similar over the bus 11. In this embodiment, when adjusted control data is stored, the address thereof is swapped with that of the data area in which is stored pre-adjustment data, so that the read selection circuit 9 always selects the data area set to the first address based on data stored in the swap register 5.

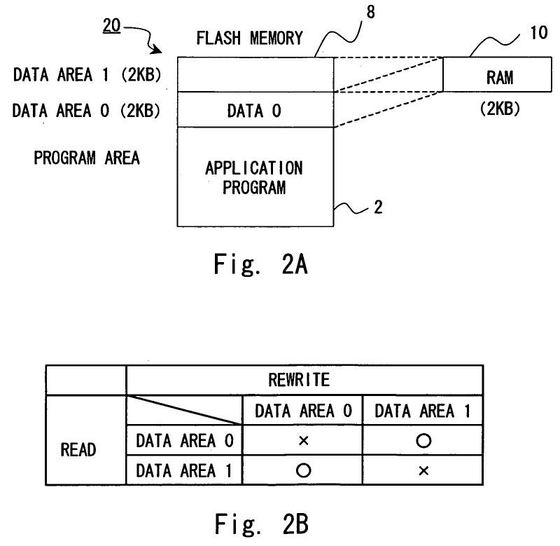

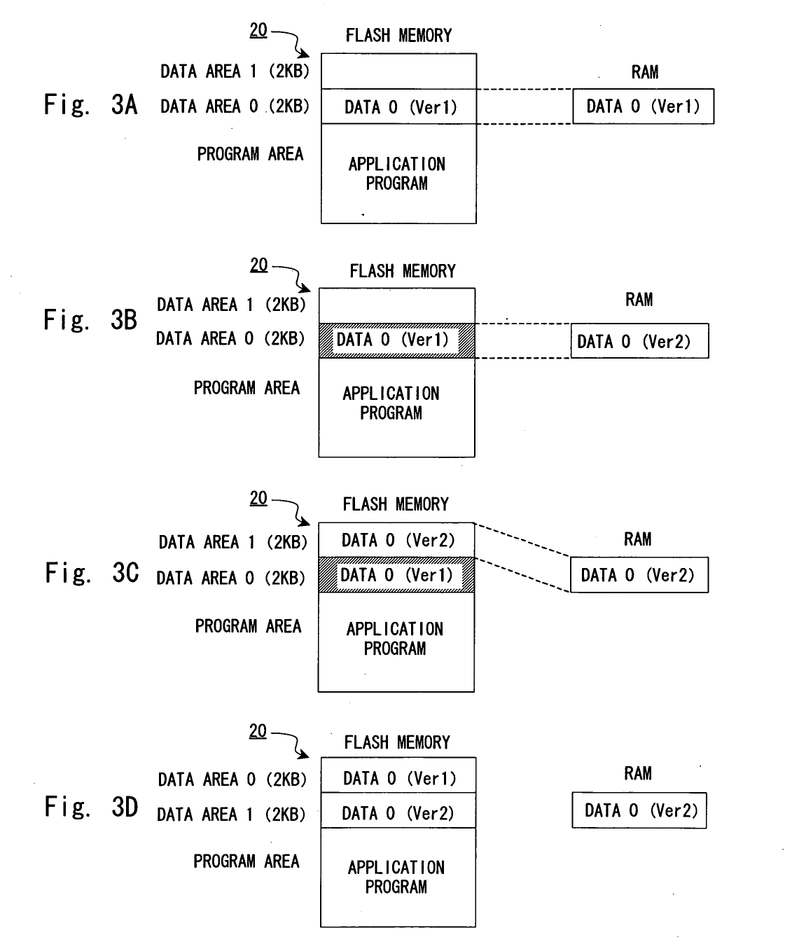

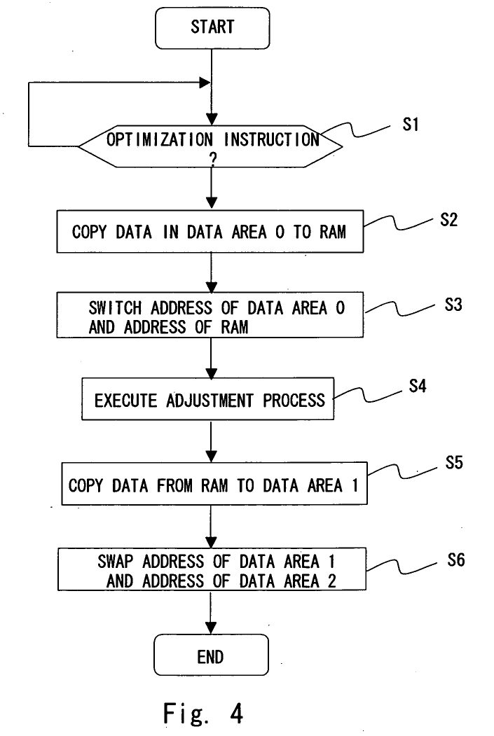

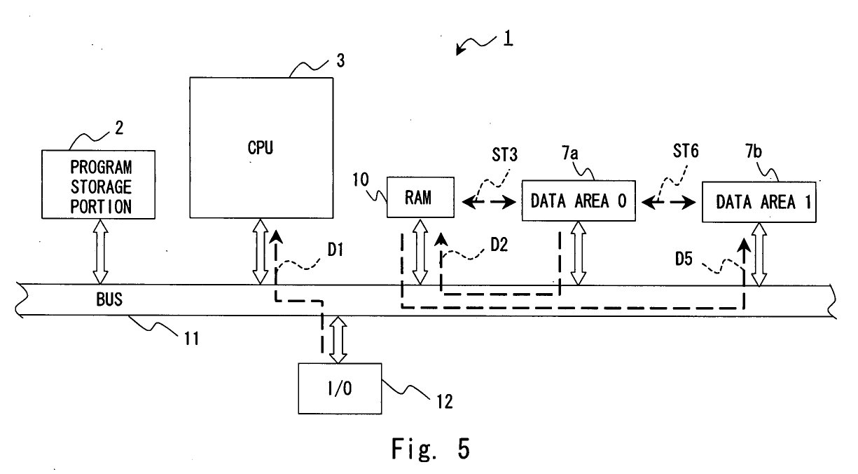

Next, the method of data optimization in this embodiment is explained. FIG. 2A shows the memory map of storage areas of the microcomputer 1 in this embodiment, and FIG. 2B shows the accessibility of data areas. FIG. 3A through FIG. 3D show the manner of data area optimization through an optimization processing procedure, FIG. 4 is a flowchart showing the optimization method in this embodiment, and FIG. 5 is a schematic drawing to explain the method of data optimization for the microcomputer 1 shown in FIG. 1.

Here, an explanation is given for the case in which the two data areas 7a and 7b (flash memory 8) and the program area (program storage area 2) which are storage areas in the microcomputer 1 are mapped as in the memory map 20 shown in FIG. 2A. Below, the data areas 7a and 7b are taken to be data area 1 and data area 0.

Data 0 is stored as pre-adjustment control data in data area 0, and an application program which uses the data 0 to execute control of the controlled equipment is stored in the program area. The data capacities of the RAM 10 and data areas 1 and 0 used when optimizing control data are each 2 kB. The addresses of the data areas 0 and 1 in the memory map 20 can be switched in RAM 10.

As stated above, these data areas 1 and 0 as well as the program area comprise different memory macros, and read and write processing can be executed separately as necessary. That is, as shown in FIG. 2B, the data areas 0 and 1 of flash memory can operate with one being read while the other is being overwritten. However, data area 0 cannot be simultaneously overwritten and read, nor can data area 1 be simultaneously overwritten and read.

In such a state, normally the microcomputer 1 shown in FIG. 1 uses the data 0 of data area 0 to execute operation. That is, data area 0 is set as the data area which is normally accessed. Below, this data 0 is referred to as “data 0 (Ver 1)”. In this case, as shown in FIG. 4 and FIG. 5, when an optimization start instruction D1 to adjust the data 0 (Ver 1) in data area 0 to optimum values is output from an external device via the I/O interface portion 12, due to user operation or similar, the CPU 3 receives this instruction and starts adjustment processing (step S1). When adjustment processing is started, first the data 0 (Ver 1) for adjustment is copied to RAM 10 (step S2, FIG. 3A).

Next, among memory map addresses 20, the CPU 3 switches the address of data area 0 in flash memory and the address of RAM 10 (step S3, ST3 in FIG. 5). By thus mapping RAM 10 to the address of data 0, the RAM 10 substitutes in subsequent accesses of data area 0. In this state, adjustment processing of data 0 (Ver 1) is executed. In adjustment processing, the CPU 3 calculates optimum values of control data so as to optimally control the controlled equipment; hence the CPU 3 executes the application program while reading values of data 0 in RAM 10, and sequentially overwrites data 0 values in RAM 10 to search for optimum values. When an optimum value is fixed, the value is set in RAM 10 as data 0 (Ver 2) (FIG. 3B, D5 in FIG. 5).

The optimized data 0 (Ver 2) is then copied from RAM 10 to data area 1 of flash memory (step S5, D5 in FIG. 5). When data 0 (Ver 2) is written to data area 1, the swap register 5 swaps the address of data area 1 and the address of data area 0.

Next, the swap method is explained. As the method for swapping data areas, in this embodiment, a swap register 5 is incorporated; for example, when SWAP=0, the data area 0 is used as the data area normally accessed by the CPU 3, and the data area 1 is used as an adjustment area for writing adjusted control data after optimization. Conversely, when SWAP=1, data area 1 is used as the data area, and data area 0 is used as the adjustment area for writing data after optimization. In other words, when SWAP=0, data area 0 is recognized as the data area of the first address, and data area 1 is recognized as the data area of the second address, whereas when SWAP=1, data area 0 is recognized as the data area of the second address, and data area 1 is recognized as the data area of the first address. Thus data areas can be swapped through a simple method.

Prior to adjustment processing, when the swap register 5 is set to SWAP=0 and adjustment processing is performed, on receiving notification from the CPU 3 that adjustment processing has ended the setting of the swap register 5 is changed to SWAP=1. As a result, data area 0, which prior to adjustment processing had been used as the normal data area, is used as the area for adjustment, and is exchanged with data area 1, which had been used as the area for adjustment. Subsequently the CPU 3 accesses data area 1 as the normal data area. Thus by means of the swap register 5, data area addresses are managed using an extremely simple and uncomplicated circuit configuration, so that swapping of data areas can be performed.

As another swapping method, the above-described swapping register can be mapped to a nonvolatile memory area. By this means, it is possible to determine whether data which currently is to be accessed is in data area 0 or in data area 1, and even when power is turned off there is no loss of information indicating which of data areas 0 and 1 is the normal data area and which is the area used for adjustment. That is, when a swap register 5 is used the contents of the register are returned to an initial state when power is cut off, so that prior to turning off power it is necessary to write back the final data to the normal data area, which may for example be data area 0; but by mapping the swap register 5 to a nonvolatile memory area, there is no longer a need to write back data to the data area before shutting off the power.

In this embodiment, by providing flash memory having data areas with for example twice the storage capacity of a data area for storing control data used to control equipment, configured such that each data area can be rewritten and read separately, as well as RAM with a capacity equal to or greater than the erasure unit in the data areas, control data which is normally used can be stored in one of the data areas, and data subjected to adjustment processing can be written to the other data area, so that data adjustment processing can be performed while executing the application program. Hence adjusted data can be written to flash memory without terminating the application program, and consequently the application program can continue to be executed even when, for example, adjustment processing for control data ends in one block which is an erasure unit.

Further, the capacity of the RAM 10 need only be for example the storage capacity enabling storage of one block's worth of control data, that is, at least equal to or greater than the erasure unit for the flash memory 8; hence adjustment processing of control data can be executed using even a small amount of RAM 10.

Further, by for example providing a swap register 5 as a means of swapping addresses, instead of swapping the two physical data areas 0 and 1 after adjustment processing is ended, one of the two data areas 0, 1 can be used as a data area for storing current control data and the other data area can be used as an adjustment area for storing past control data or control data after adjustment; and by swapping the data areas upon completion of adjustment of control data through optimization processing, it is possible to ascertain which of the two data areas 0, 1 stores the most recent control data. A flag is stored in the register 5, and the flag is used to judge which of the data areas stores the most recent control data, so that there is no increase in circuit size.

### Embodiment 2

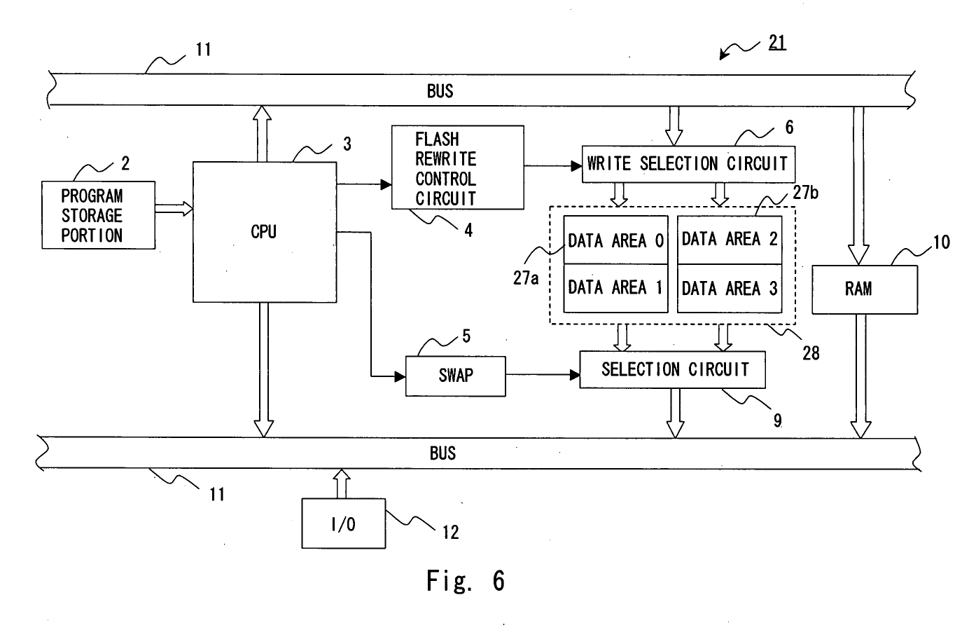

Next, Embodiment 2 of the invention is explained. FIG. 6 is a block diagram showing the microcomputer 21 in Embodiment 2 of the invention. The above-described flash memory had two data areas, but the flash memory in this embodiment has four data areas. Otherwise the configuration is similar to Embodiment 1 shown in FIG. 1; constituent components similar to those in FIG. 1 are assigned the same symbols, and detailed explanations are omitted.

As shown in FIG. 6, the microcomputer 21 of this embodiment has flash memory 28 comprising a first memory macro 27a as a first nonvolatile storage portion having data areas 0 and 1, and a second memory macro 27b as a second nonvolatile storage portion having data areas 2 and 3. Any one data area in the first memory macro 27a or second memory macro 27b is used as a data area for normal reading of the latest control data by the CPU 3, and another data area is used as an adjustment area for writing adjusted control data after optimization.

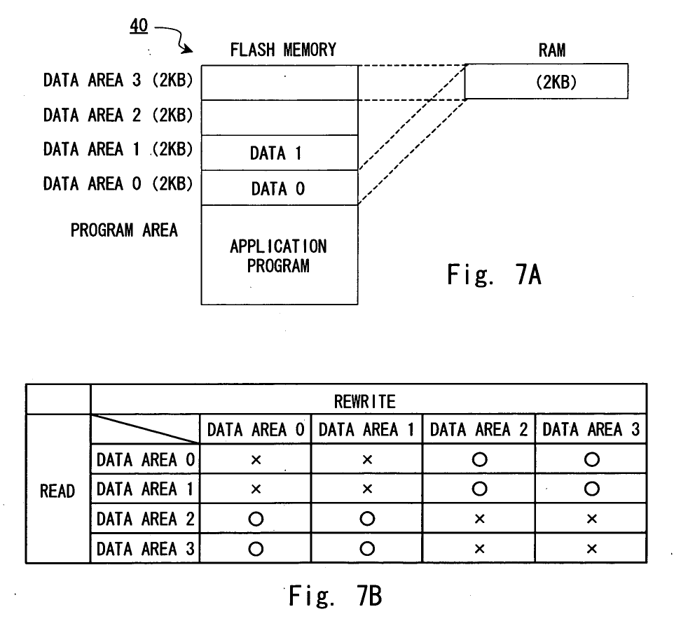

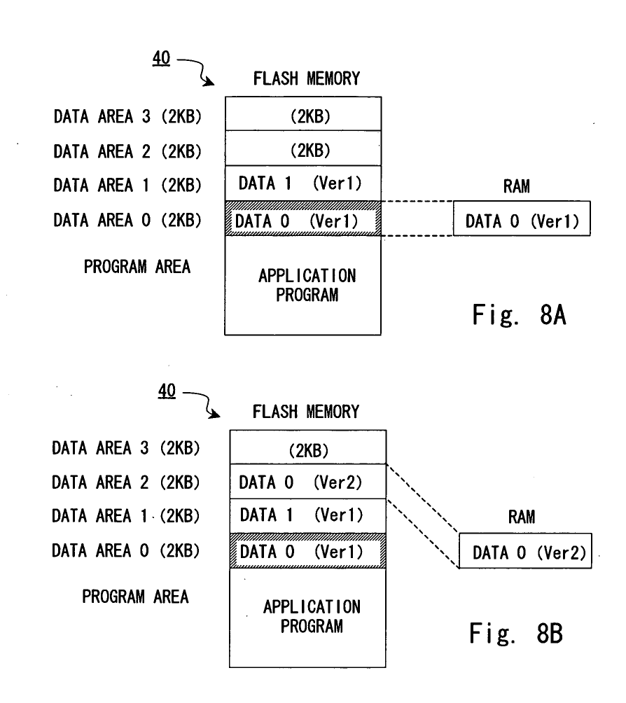

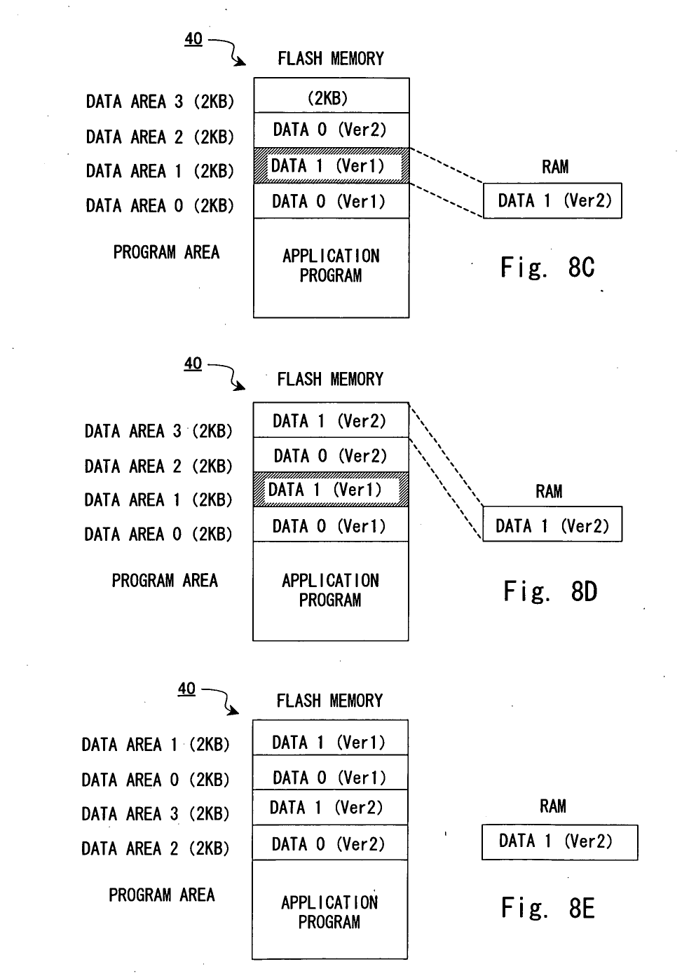

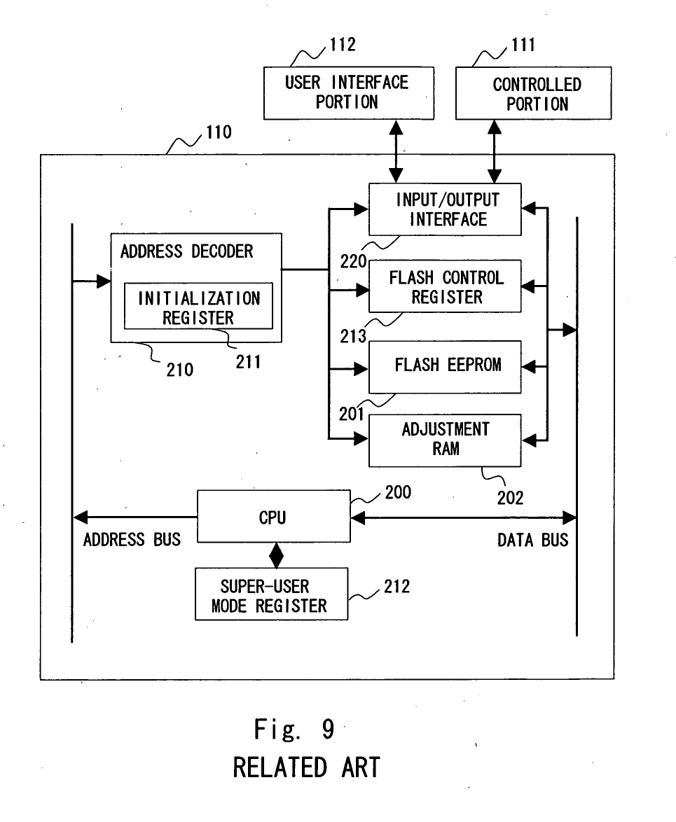

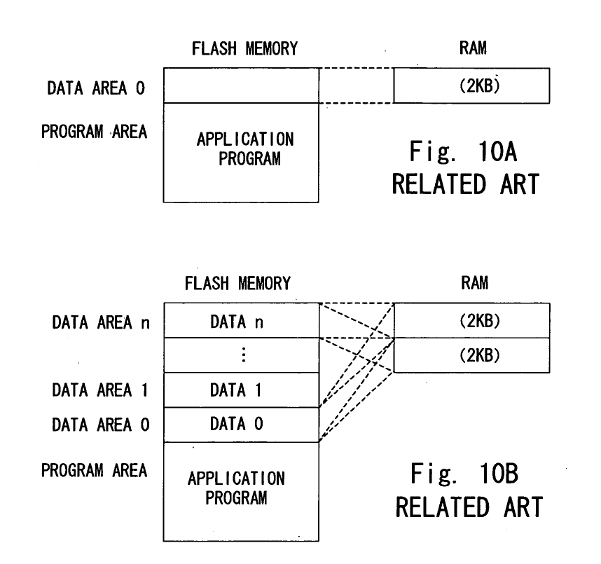

The data areas 0, 1, 2, 3 store data 0, 1, 2, 3 comprising block data which are, for example, the erasure unit for the flash memory 28. In this embodiment also, as substitute memory for the flash memory 28, RAM 10 is provided with the same storage capacity (2 kB) as the block data. FIG. 7A shows a memory map of storage areas in the microcomputer 21 of this embodiment; FIG. 7B shows the accessibility of data areas. FIG. 8A through FIG. 8E show the procedure of adjustment processing to adjust the control data in a data area to values appropriate to the controlled equipment.

Because the data areas 0, 1 and the data areas 2, 3 are comprised by different memory macros, for example, data area 0 and data area 3 can be accessed separately, as indicated in FIG. 7A. That is, as shown in FIG. 7B, during rewriting of data areas 0 and 1, data can simultaneously be read from data areas 2 and 3, and during reading of data areas 0 and 1, data areas 2 and 3 can simultaneously be rewritten. However, during reading or writing of data in data area 0, data cannot be read from or written to data area 1.

Next, the data optimization method of this embodiment is explained. The microcomputer 21 controls the controlled equipment using data 0 (Ver 1) and data 1 (Ver 1) in data areas 0 and 1. Similarly to the above-described Embodiment 1, when the CPU 3 is notified via the I/O interface portion 12 of an optimization instruction from outside, first the data 0 (Ver 1) in data area 0 is copied to RAM 10 (FIG. 8A), and the CPU 3 uses the data 0 (Ver 1) copied to RAM 10 to search for optimum values of the control data. When data 0 (Ver 2) which is the optimum values is determined, this data is written to for example data area 2 of the adjustment memory macro (FIG. 8B).

Similarly, data 1 (Ver 1) in data area 1 is copied to RAM 10 (FIG. 8C), and the CPU 3 uses the data 1 (Ver 1) copied to RAM 10 to search for optimum values of the control data. When data 1 (Ver 2), which are the optimum values, is determined, this data 1 (Ver 2) is written to for example data area 3 of the adjustment memory macro (FIG. 8D). Finally, the swap register 5 is used to swap the addresses of data areas 0, 1 and data areas 2, 3 (FIG. 8E).

As a result, the second memory macro 27b becomes the normal data area, and the first memory macro 27a becomes the adjustment area; when controlling the controlled equipment, physically the controlled equipment can be controlled using the data 0, 1 (Ver 2) stored in data areas 2, 3, without reading data 0, 1 (Ver 1) which is pre-adjustment control data stored in data areas 0, 1 of the second memory macro 27b.

By means of this embodiment, advantageous results similar to those of the above-described Embodiment 1 are obtained; by providing flash memory having data areas which can be written and read separately, RAM for temporarily storing data for data area optimization, and data area management means such as the swap register 5 to manage the addresses of data areas in flash memory 28, data rewriting can be performed while executing the application program. Further, even when calibration of a large quantity of control data is necessary, if RAM is provided having at least the memory capacity of flash memory erasure units, then control data can be continuously calibrated without interrupting the control program, so that adjustment processing can be executed efficiently even for RAM with a small storage capacity.

It is apparent that the present invention is not limited to the above embodiment, that may be modified and changed without departing from the scope and spirit of the invention. For example, in FIG. 6, the RAM 10 was explained as having capacity sufficient to move one block of data; but by employing RAM having capacity sufficient to store two data sets (data 0, 1) in the data areas 0, 1, optimization processing of the control data stored in data areas 0, 1 can be performed at once, so that optimization processing can be performed more rapidly.

1. An electronic control device, which executes adjustment processing to adjust control data to be appropriate for an equipment to be controlled, comprising:
a nonvolatile storage portion, having a plurality of data storage areas;
substitute memory, for use as a substitute for the nonvolatile storage portion when executing the adjustment processing of pre-adjustment control data, which is control data prior to adjustment stored in a data storage area of the nonvolatile storage portion; and,
an adjustment processing portion, which reads the pre-adjustment control data from at least one data storage area among the plurality of data storage areas, executes adjustment processing of the pre-adjustment control data using the substitute memory, and writes adjusted control data, which is control data subjected to the adjustment processing, to another data storage area in the nonvolatile storage portion which is capable of writing independently of reading of the at least one data storage area.

2. The electronic control device according to claim 1, wherein the nonvolatile storage portion comprises a first nonvolatile storage portion, having a first data storage area and a first access portion which reads, erases and writes data in the first data storage area, and a second nonvolatile storage portion, having a second data storage area and a second access portion which reads, erases and writes data in the second data storage portion, and wherein the pre-adjustment control data is stored in one of the first and second data storage areas, and the adjusted control data is written to the other data storage area.

3. The electronic control device according to claim 2, comprising an address management portion which manages the addresses of the first and the second data storage areas, and wherein the address management portion sets the address of one of the first and the second data storage areas as a first address indicating the address of the data storage area in which the pre-adjustment control data is stored, and sets the address of the other data storage area as a second address indicating the address of the data storage area to which the adjusted control data is written.

4. The electronic control device according to claim 3, wherein the address management portion exchanges the second address with the first address after the end of the adjustment processing.

5. The electronic control device according to claim 3, wherein the address management portion stores the addresses of the first and second data storage areas in association with the first address or with the second address.

6. The electronic control device according to claim 4, wherein control data in the data storage area set as the first address is used when controlling the equipment to be controlled.

7. The electronic control device according to claim 1, wherein the substitute memory is volatile memory having storage capacity of a magnitude equal to or greater than the unit of erasure of the nonvolatile storage portion.

8. A data adjustment method of an electronic control device, which executes adjustment processing to adjust control data to be appropriate for an equipment to be controlled, comprising:
reading pre-adjustment control data, which is control data before adjustment, from at least one data storage area of a nonvolatile storage portion which has a plurality of data storage areas;
executing adjustment processing using substitute memory which can be used to substitute for the nonvolatile storage portion; and,
writing adjusted control data, which is control data adjusted by the adjustment processing, to another data storage area in the nonvolatile storage portion which is capable of writing independently of the reading of the one or more data storage area.

9. The data adjustment method according to claim 8, wherein the nonvolatile storage portion comprises a first nonvolatile storage portion having a first data storage area and a first access processing portion which reads, erases and writes data in the first data storage area, and a second nonvolatile storage portion having a second data storage area and a second access processing portion which reads, erases and writes data in the second data storage area; and wherein
the pre-adjustment control data is read from one of the first and the second data storage areas in the reading pre-adjustment control data, and
the adjusted control data is written to the other of the first and second data storage areas in the writing adjusted control data.

10. The data adjustment method according to claim 9, wherein, the reading step comprises setting the address of one of the first and the second data storage areas as a first address indicating the data storage area in which the pre-adjustment control data is stored, and setting the address of the other storage area as a second address indicating the data storage area to which the adjusted control data is written.

11. The data adjustment method according to claim 10, wherein, after the adjustment processing, the second address is exchanged with the first address.
